(19) United States
(12) Patent Application Publication
(10) Pub. No.: US 2012/0162473 A1
(43) Pub. Date: Jun. 28, 2012

(54) ELECTRONIC APPARATUS, IMAGE CAPTURING APPARATUS AND METHOD THEREOF

(75) Inventor: SHIN-HAO CHENG, Taichung City (TW)

(73) Assignee: ALTEK CORPORATION, Hsinchu (TW)

(21) Appl. No.: 13/096,329

(22) Filed: Apr. 28, 2011

(30) Foreign Application Priority Data
Dec. 28, 2010 (TW) 099146336

(51) Int. Cl. H04N 5/76

(52) U.S. Cl. 348/231.99; 348/E05.031

(57) ABSTRACT

The present invention discloses an electronic apparatus, an image capturing apparatus and a method thereof. The image capturing method comprises the following steps of: capturing a plurality of temporal images by an image capturing module, each temporal image comprising at least one similar region; determining whether or not each temporal image having at least one similar object except the similar region by a processing module; integrating the similar object and similar region by the processing module to output an output image when each temporal image having at least one similar object.

### FIELD

The exemplary embodiment(s) of the present invention relates to a field of an electronic apparatus, an image capturing apparatus and a method thereof. More specifically, the exemplary embodiment(s) of the present invention relates to an electronic apparatus, an image capturing apparatus and a method thereof that could continuously superimpose a trajectory of an object on an output image by taking out the interested object through analyzing a difference between any two adjacent continuous images.

### BACKGROUND

The conventional electronic apparatuses such as a convenience and light and handy portable apparatus (including digital camera, PDA and cell phone, etc.) are broadly applied to every field in the modern society having a highly developed information communication system. The functions of the portable apparatus are getting manifold, and there is more and more PDA or cell phone having a built-in digital camera. The pre-view screen of theses apparatuses are getting bigger, the dots per inch is raised, and the CPU is enhanced. Therefore, some image processing or special effects could be preformed on the portable apparatus. However, relative to the PC, the calculate ability, the memory capacity or the power supply of the portable apparatus is relatively limited compared with the personal computer. Thus, it is a big challenge to provide a variety viewing effects to users on the portable apparatus having limited sources by a best algorithm.

Base on the aforementioned reasons, a frame generated by superimposing several full-frame images is often blurred. Thus the “Multi-Frame Shot” technique has never been implemented on the portable apparatus mentioned above.

The present invention thus provides an algorithm for users identifying the moving subjects captured by the portable apparatus having a image capturing function through comparing the pixels of adjacent the full-frame images, and obtaining the image blocks and the displacement vector of the moving subjects for image superimpose processing, and thus the image blurred phenomenon could be avoid when superimpose several full-frame images. The technical threshold thus could be effectively low down to let users determine the wonderful extent of the memory according to “creativity” easily.

### SUMMARY

To solve the problems in the conventional arts, it is a primary object of the present invention to provide an electronic apparatus, an image capturing apparatus and a method thereof to solve the problem that an image is blur caused by superimposing several full-frame images.

To achieve the above object, an image capturing apparatus according to the present invention is disclosed, which comprises an image capturing module and a processing module. The image capturing module captures a plurality of temporal images, each temporal image comprises at least one similar region; The processing module determines whether or not each temporal image having at least one similar object except the similar region, and integrates the similar object and the similar region to output an output image when the temporal images having the similar object.

Wherein the processing module determines whether or not each temporal image having the similar object by variable block size motion compensation (VBSMC).

Wherein when the processing module determines that the temporal images do not have the similar object, and then the processing module determines whether or not each temporal image has at least one different object, and when the each temporal image has the different objects, the processing module integrates the different objects and the similar region to output the output image.

To achieve another object, an image capturing method according to the present invention is disclosed, which comprises the following steps of: capturing a plurality of temporal images by an image capturing module, each temporal image comprising at least one similar region; determining whether or not each temporal image having at least one similar object except the similar region by a processing module; and integrating the similar object and similar region by the processing module to output an output image when each temporal image having the similar object.

Wherein the method further comprises the step of determining whether or not each temporal image having the similar object by variable block size motion compensation (VBSMC) by the processing module.

Wherein the method further comprises the step of determining whether or not each temporal image has at least one different object by the processing module when the processing module determines that the temporal images do not have the similar object; and integrating the different objects and the similar region to output the output image by the processing module when the each temporal image has the different objects.

To achieve another object, an electronic apparatus according to the present invention is disclosed, which comprises a body and an image capturing apparatus mentioned above. The image capturing apparatus being disposed in the body.

With the above arrangements, the electronic apparatus, the image capturing apparatus and the method thereof according to the present invention has one or more of the following advantages:

(1) The electronic apparatus, the image capturing apparatus and the method thereof in accordance with the present invention could raise the sharpness of an image by recognizing and then superimposing the similar object and the similar region of each temporal image.

(2) The electronic apparatus, the image capturing apparatus and the method thereof in accordance with the present invention could indentify the similar region of each temporal image and then capture the different object in every temporal image, and integrate the different object and the similar region to solve the problem that the similar region of the conventional superimposed image is blur after the integrating.

With these and other objects, advantages, and features of the invention that may become hereinafter apparent, the nature of the invention may be more clearly understood by reference to the detailed description of the invention, the embodiments and to the several drawings herein.

### BRIEF DESCRIPTION OF THE DRAWINGS

The exemplary embodiment(s) of the present invention will be understood more fully from the detailed description given below and from the accompanying drawings of various embodiments of the invention, which, however, should not be taken to limit the invention to the specific embodiments, but are for explanation and understanding only.

FIG. 1 illustrates a block diagram of an image capturing apparatus in accordance with the present invention;

FIG. 2A illustrates a schematic diagram of the temporal images of the first embodiment of an image capturing apparatus in accordance with the present invention;

FIG. 2B illustrates a schematic diagram of an out image of the first embodiment of an image capturing apparatus in accordance with the present invention;

FIG. 3A illustrates a schematic diagram of the temporal images of the second embodiment of an image capturing apparatus in accordance with the present invention;

FIG. 3B illustrates a schematic diagram of an out image of the second embodiment of an image capturing apparatus in accordance with the present invention;

FIG. 4 illustrates a schematic diagram of the third embodiment of an image capturing apparatus in accordance with the present invention;

FIG. 5 illustrates a schematic diagram of an embodiment of an electronic apparatus in accordance with the present invention; and

FIG. 6 illustrates a flow chart of an image capturing method in accordance with the present invention.

### DETAILED DESCRIPTION

Exemplary embodiments of the present invention are described herein in the context of an electronic apparatus, an image capturing apparatus and a method thereof.

Those of ordinary skilled in the art will realize that the following detailed description of the exemplary embodiment(s) is illustrative only and is not intended to be in any way limiting. Other embodiments will readily suggest themselves to such skilled persons having the benefit of this disclosure. Reference will now be made in detail to implementations of the exemplary embodiment(s) as illustrated in the accompanying drawings. The same reference indicators will be used throughout the drawings and the following detailed description to refer to the same or like parts.

In accordance with the embodiment(s) of the present invention, the components, process steps, and/or data structures described herein may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. Where a method comprising a series of process steps is implemented by a computer or a machine and those process steps can be stored as a series of instructions readable by the machine, they may be stored on a tangible medium such as a computer memory device (e.g., ROM (Read Only Memory), PROM (Programmable Read Only Memory), EEPROM (Electrically Erasable Programmable Read Only Memory), FLASH Memory, Jump Drive, and the like), magnetic storage medium (e.g., tape, magnetic disk drive, and the like), optical storage medium (e.g., CD-ROM, DVD-ROM, paper card and paper tape, and the like) and other known types of program memory.

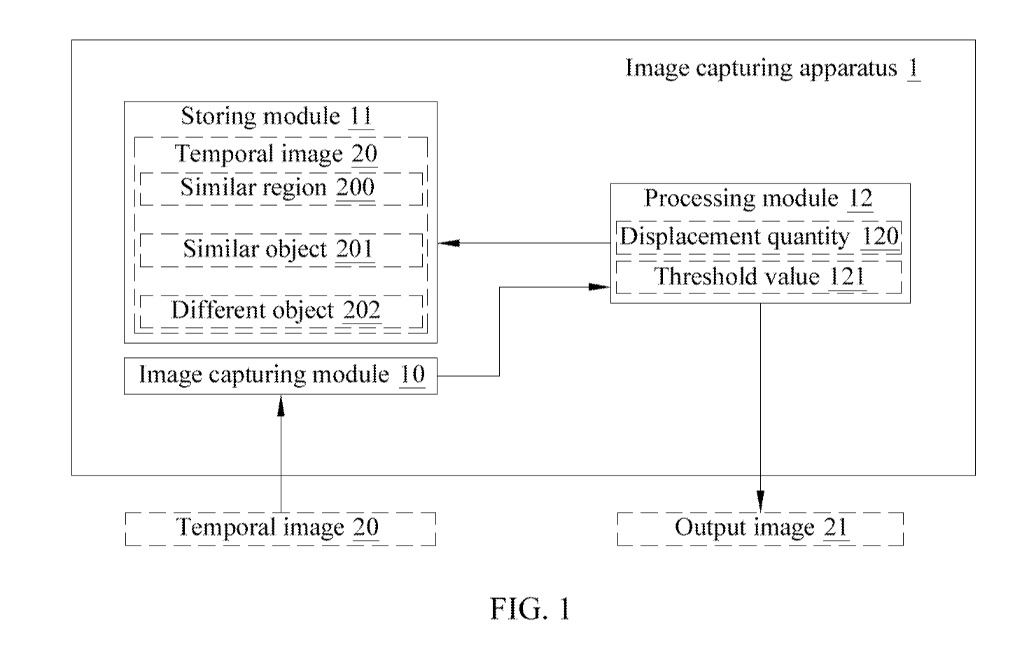

Please refer to FIG. 1, which illustrates a block diagram of an image capturing apparatus in accordance with the present invention. As shown in this figure, the image capturing apparatus 1 in accordance with the present invention comprises an image capturing module 10, a storing module 11 and a processing module 12. The image capturing module 10 comprises at least one light sensor such as a complementary metal-oxide-semiconductor (CMOS) or charge-coupled-device (CCD), a camera lens and a lens set. The storing module 11 could be an embedded memory, an external memory card or the combination of both. The processing module 12 is electrical connected to the image capturing module 10 and the storing module 11, and could be a central processor or a microprocessor. In some preferred embodiments, the image capturing apparatus 1 could be a digital camera or a digital video recorder.

The image capturing module 10 could capture a plurality of temporal images 20 having at least one similar region 200 and store the temporal images 20 in the storing module 11. The processing module 12 connects to the image capturing module 10 and determines whether or not each temporal image 20 having at least one similar object 201 except the similar region 200. If the temporal images 20 have the similar object 201, the processing module 12 will integrates or superimposes the similar object 201 and the similar region 200 to output an output image 21. In some preferred embodiments, the output image 21 could be stored in the storing module 11 with file form, and the temporal images 20 could be stored in the storing module 11 with data form. Besides, the output image 21 is preferred to be provided to users for viewing, but the temporal images 20 could not be inspected by users.

Besides, when the processing module 12 determines that the temporal images 20 do not have the similar object 201, the processing module will further determine whether or not each temporal image 20 has at least one different object 202. When each temporal image 20 has the different objects 202, the processing module 12 will integrate or superimpose the different objects 202 and the similar region 200 to output the output image 21.

In some preferred embodiments, the processing module 12 determines the displacement of every pixel between different temporal images 20 by variable block size motion compensation (VBSMC). When a pixel is displaced between two adjacent temporal images 20, the processing module 12 could compare these two adjacent temporal images 20 by using the variable block size motion compensation method, and separate the similar regions having similar pixels from the temporal images 20 and set these regions as the non-changed region (i.e., similar region 200). The processing module 12 further takes out the displaced region according to the result calculated by VBSMC, and detect the displacement quantity 120 between the later temporal image and the former temporal image. When the displacement quantity 120 is smaller than a threshold value 121, then the processing module 12 will set this displaced region as a displaced subject (i.e., similar object 201); and when the pixels of the displaced region in the later temporal image and the pixels of the displaced region in the former temporal image are totally different, then the processing module 12 will set this displaced region as an emerging subject (i.e., different objects 202).

After integrating or superimposing several temporal images 20 by the aforementioned method, the processing module 12 then outputs an output image 21. The output image 21 would indicate the continuous trajectory of the similar object 201 relative to the similar region 200, or the superimposed image by integrating the different objects 202 at different sites relative to the similar region 200.

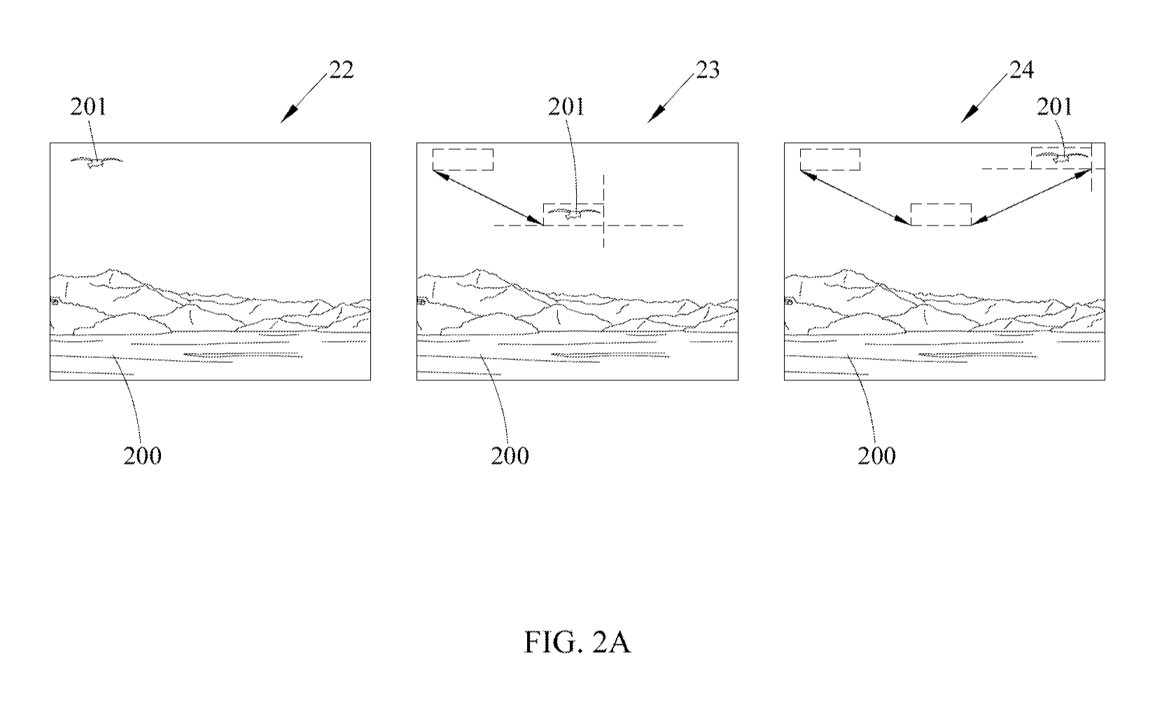

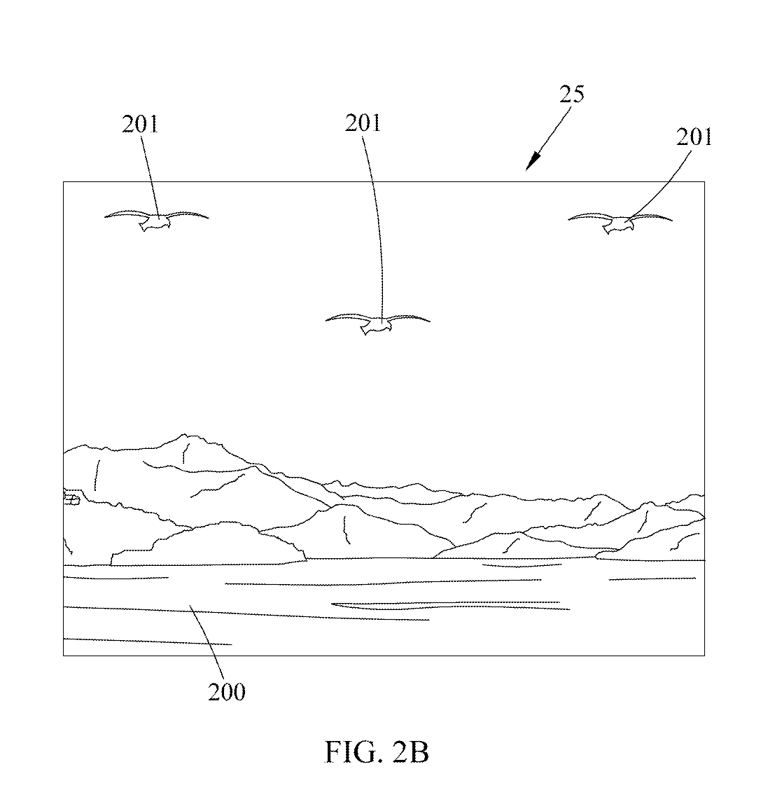

Please refer to FIG. 2A, which illustrates a schematic diagram of the temporal images of the first embodiment of an image capturing apparatus in accordance with the present invention. In the present invention, the number and the time interval of continuous shooting could be entered by users. As shown in this figure, the processing module of the present embodiment controls the image capturing module to capture three images continuously (from up to bottom is the first temporal image 22, the second temporal image 23 and the third temporal image 24), and the time interval between each temporal image is one second. As show in the figure, there is a bird flying across a river, and the processing module processes an analysis to every temporal image simultaneously when taking these temporal images. In this figure, the The processing module determines the displacement of every pixel between each temporal image by variable block size motion compensation (VBSMC). When some pixels are displaced between two adjacent temporal images, the processing module would compare these two adjacent temporal images by using the variable block size motion compensation method, and separate the similar regions having similar pixels from the temporal images and set these regions as the non-changed region. In the present embodiment, the non-changed region is the similar region 200 (i.e., the river part). Second, the processing module further takes out a displaced region according to the result calculated by VBSMC, and detect the displacement quantity between the second temporal image 23 and the first temporal image 22. In this embodiment, the displaced region indicates the bird flying, and thus the displacement quantity is higher than a predetermined threshold value, and the processing module would set the displaced region as a similar object 201 (i.e., the bird) and generate a temporal superimposed image which will be stored in the storing module (not shown in the figure) by superimposing the similar object 201 captured from the second temporal image 23 on the first temporal image 22. After the aforementioned processes, the processing module further analyses the similar region 200 and the similar object 201 in the second temporal image 23 and the third temporal image 24, and the processing module again superimposes the similar object 201 captured out from the third temporal image 24 on the temporal superimposed image to form the output image 25 as shown in FIG. 2B for viewing by users. By this way, users could integrate several continuously-shot images in one output image easily, and thus the present invention could effectively solve the problem that the camera uses the memory when continuously shooting.

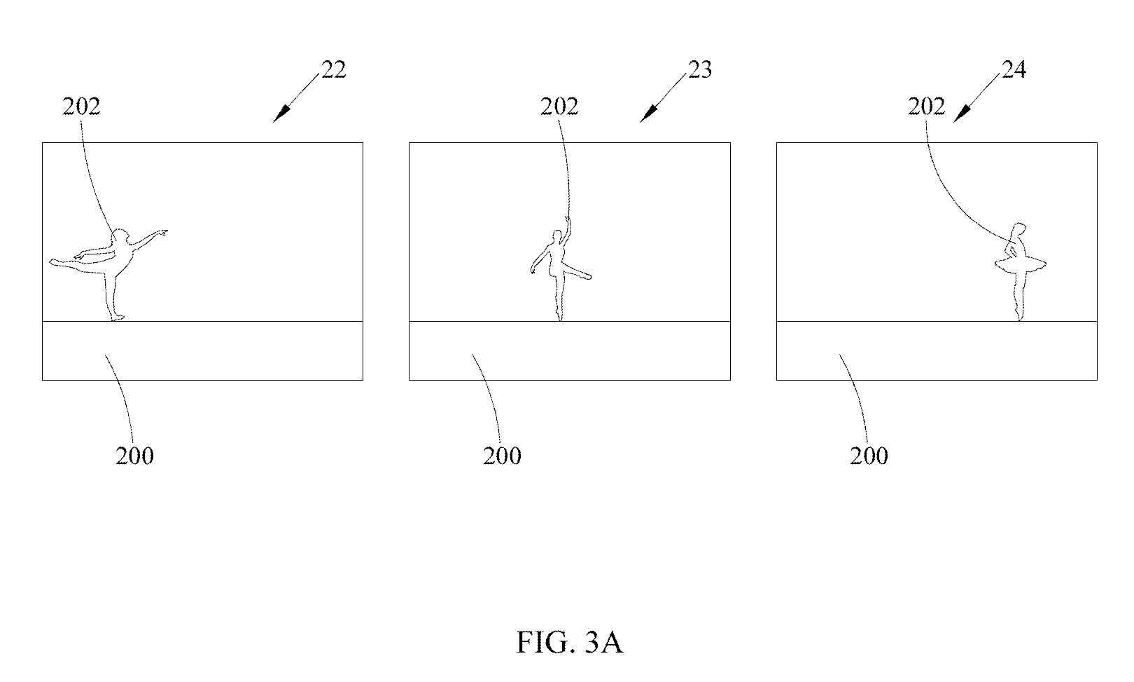

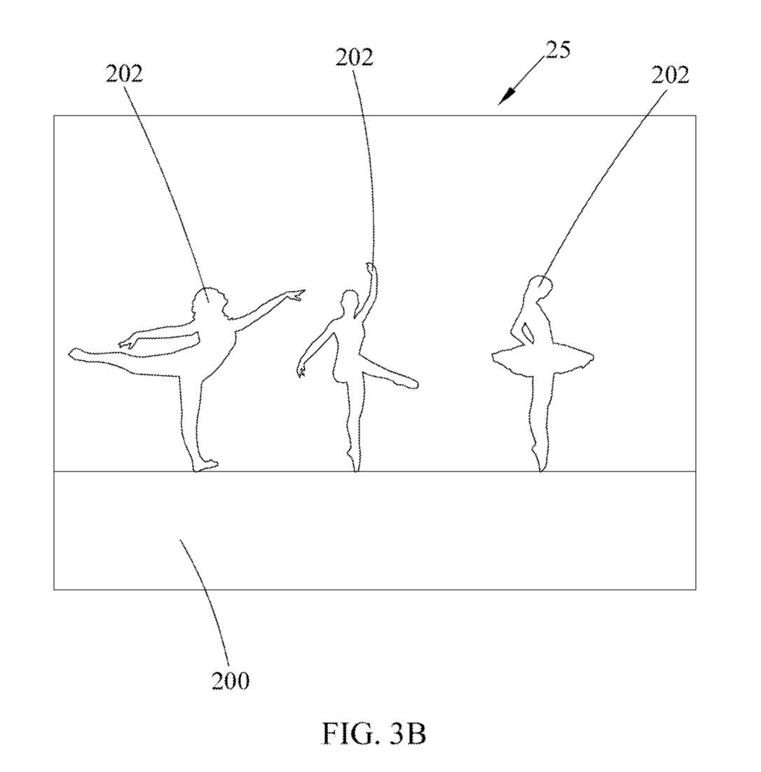

Please refer to FIG. 3A, which illustrates a schematic diagram of the temporal images of the second embodiment of an image capturing apparatus in accordance with the present invention. As shown in this figure, the biggest different between the first and the second embodiment is that the time interval and the number of the continuously-shooting image are not predetermined in the second embodiment. The second embodiment provides a shooting mode that could superimpose an emerging different subject 202 (the model as shown in FIG. 3A) on the first temporal image 22 to form a temporal superimposed image; another emerging different subject 203 (the model as shown in FIG. 3A) would be further imposed on the temporal superimposed image to form the output image 25 as shown in FIG. 3B. The difference between the first and second embodiment is that the pixels of the newly emerging object are different from one to the others, thus the processing module would directly set these newly emerging pixels as the different objects 202, 203, and integrates these different objects 202, 203 with the first temporal image to form the output image 25 as shown in FIG. 3B.

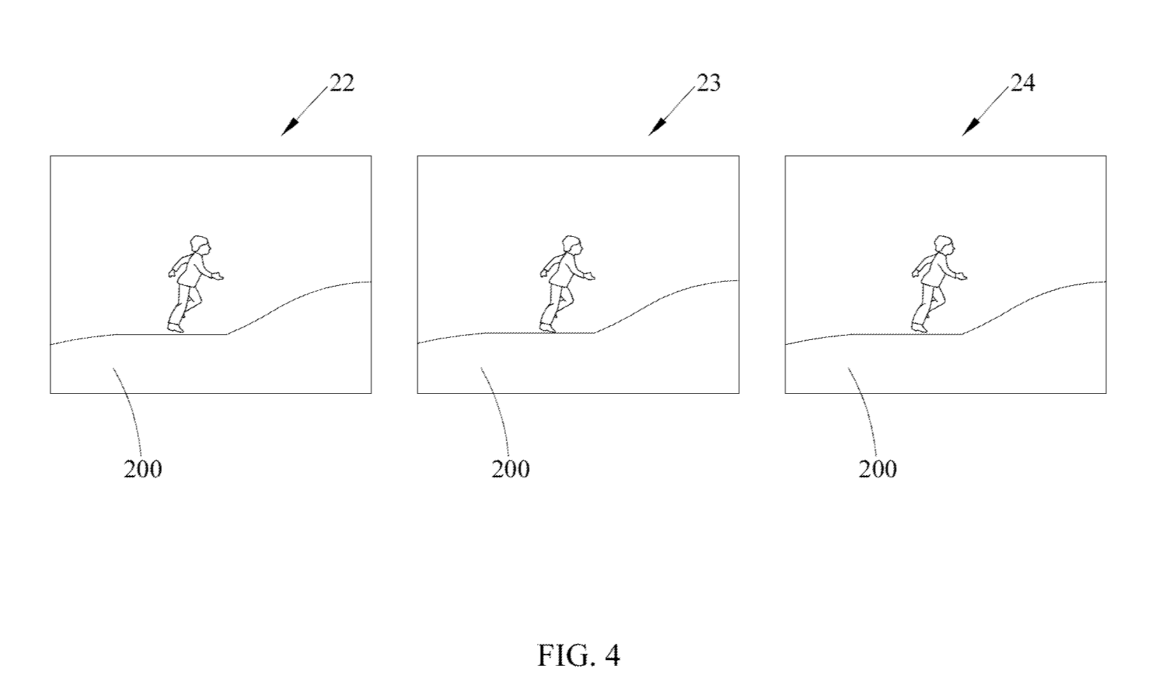

Please further refer to FIG. 4, which illustrates a schematic diagram of the third embodiment of an image capturing apparatus in accordance with the present invention. As shown in this figure, the biggest different between the first and the third embodiment is that the displacement quantity of the similar objects 201 between the temporal images is smaller than the predetermined threshold value, thus the processing module would determines each temporal image indicating a same static object, and the displacement quantity of these similar objects 201 is caused by the hand vibration when shooting. Under this situation, the processing module would not integrate these temporal images.

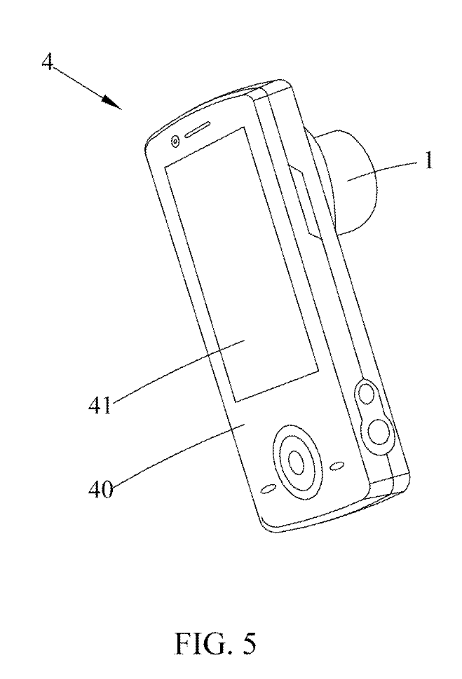

Please refer to FIG. 5, which illustrates a schematic diagram of an embodiment of an electronic apparatus in accordance with the present invention. As shown in this figure, the electronic apparatus 4 according to the present invention comprises a body 40, an input apparatus 41 and an image capturing apparatus 1. The image capturing apparatus 1 being disposed in the body and electronically connected to the input apparatus 41. The image capturing apparatus 1 comprises an image capturing module, a storing module and a processing module. The image capturing apparatus 1 mentioned here has been already described in the aforementioned embodiments, so it will not be interpreted again. However, the electronic apparatus 4 according to the present invention could be all kinds of mobile portable apparatus such as a digital camera, a multimedia player having camera function, a mobile phone having camera function, a smart phone, a navigator, a tablet computer having camera function or a personal digital assistant.

In the present embodiment, the electronic apparatus 4 could be a smart phone, and the image capturing apparatus 1 disclosed in the present invention could be embed in the electronic apparatus 4 for taking picture. Thus, the image integrating processes described above could be executed on the electronic apparatus 4 when a user taking picture through the input apparatus 41 such as a touch-controlled screen or a keystroke of the smart phone, and it is easier to capture images or process creative shooting with the present invention. The smart phone disclosed in the present embodiment is only for an example but not a limitation, men skilled in the art could easily dispose the image capturing apparatus 1 on any other portable electronic apparatus.

Even the concept of the image capturing method in accordance to the present invention is simultaneously described in the description of the image capturing apparatus disclosed in the present invention, but in order to get clearer, the following will still illustrate the flow chart of the image capturing method.

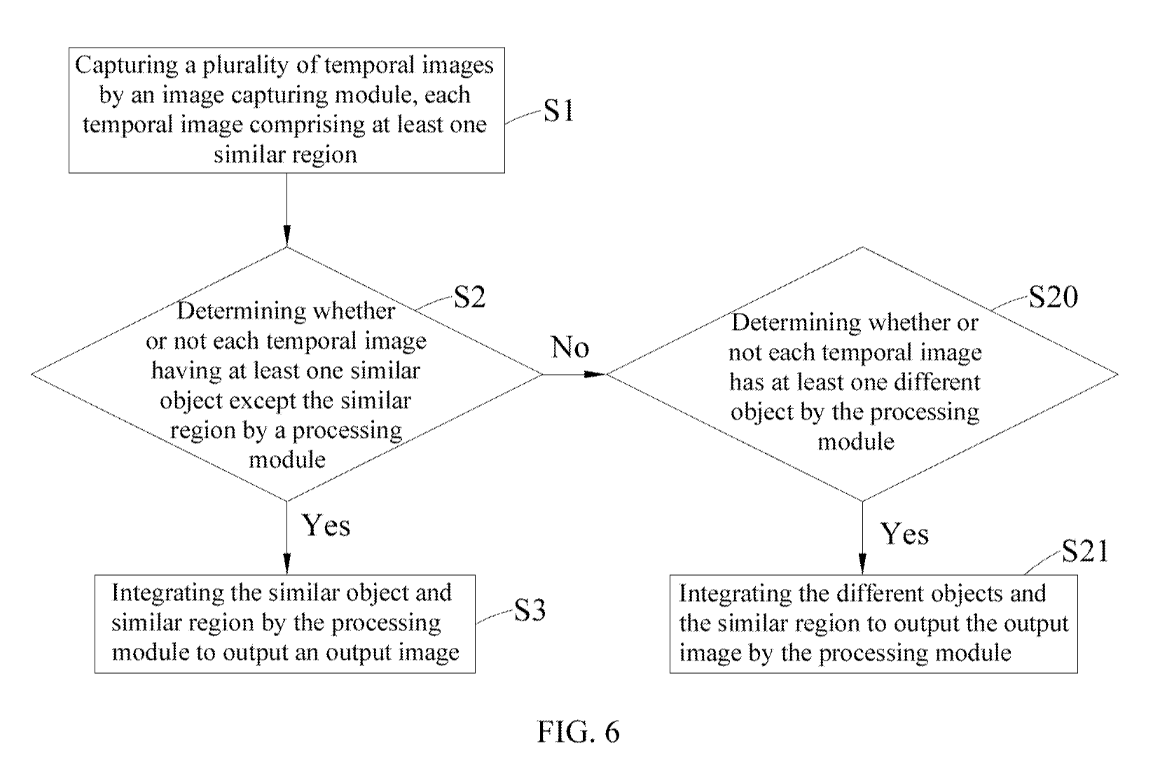

Please refer to FIG. 6, which illustrates a flow chart of an image capturing method in accordance with the present invention. As shown in this figure, the image capturing method is applicable to an image capturing apparatus which comprises an image capturing module, a storing module and a processing module. the image capturing method comprises the following steps of:

(S1) capturing a plurality of temporal images by an image capturing module, each temporal image comprising at least one similar region;

(S2) determining whether or not each temporal image having at least one similar object except the similar region by a processing module; and

(S3) integrating the similar object and similar region by the processing module to output an output image.

In the step (S2), when the processing module determines that the temporal images do not have the similar object, the image capturing method further comprises the following steps of:

(S20) determining whether or not each temporal image has at least one different object by the processing module; and

(S21) integrating the different objects and the similar region to output the output image by the processing module.

The implementation of the image capturing method in accordance with the present invention has already described in the description of the embodiments of the image capturing apparatus according to the present invention, so it will not be stated here again.

Besides, the present invention further discloses a computer readable storing media which comprises codes, and when a processing module reads and then executes the codes, the steps of image capturing method mentioned above could be finished. The media could be but not limited to CD, DVD, MD, disk, USB disk, and memory card. In addition, the present invention could further be carried out through a computer program product. The computer programs product comprises codes, and when a processing module reads and then executes the codes, the steps of image capturing method mentioned above could be finished. Selectively, the computer program product could be transmitted through internet or other ways.

In summary, the electronic apparatus, the image capturing apparatus and the method thereof in accordance with the present invention could raise the sharpness of an image by recognizing and then superimposing the similar object and the similar region of each temporal image; on the other hand, the present invention could indentify the similar region of each temporal image and then capture the different object in every temporal image, and integrate the different object and the similar region to solve the problem that the similar region of the conventional superimposed image is blur after the integrating.

While particular embodiments of the present invention have been shown and described, it will be obvious to those skilled in the art that, based upon the teachings herein, changes and modifications may be made without departing from this invention and its broader aspects. Therefore, the appended claims are intended to encompass within their scope of all such changes and modifications as are within the true spirit and scope of the exemplary embodiment(s) of the present invention.

What is claimed is:

1. An image capturing apparatus, comprising:
an image capturing module, capturing a plurality of temporal images, each temporal image comprising at least one similar region; and
a processing module, determining whether or not each temporal image having at least one similar object except the similar region, and integrating the similar object and the similar region to output an output image when the temporal images having the similar object.

2. The image capturing apparatus of claim 1, wherein the processing module determines whether or not each temporal image having the similar object by variable block size motion compensation (VBSMC).

3. The image capturing apparatus of claim 1, wherein when the processing module determines that the temporal images do not have the similar object, then the processing module determines whether or not each temporal image has at least one different object, and when the each temporal image has the different objects, the processing module integrating the different objects and the similar region to output the output image.

4. An image capturing method, comprising:
capturing a plurality of temporal images by an image capturing module, each temporal image comprising at least one similar region;
determining whether or not each temporal image having at least one similar object except the similar region by a processing module; and
integrating the similar object and the similar region by the processing module to output an output image when each temporal image having the similar object.

5. The image capturing method of claim 4, wherein the method further comprises the step of:
determining whether or not each temporal image having the similar object by variable block size motion compensation (VBSMC) by the processing module.

6. The image capturing method of claim 4, wherein the method further comprises the step of:
determining whether or not each temporal image has at least one different object by the processing module when the processing module determines that the temporal images do not have the similar object; and
integrating the different objects and the similar region to output the output image by the processing module when the each temporal image has the different objects.

7. An electronic apparatus, comprising:
a body; and
an image capturing apparatus, disposed in the body, comprising:
an image capturing module, capturing a plurality of temporal images, each temporal image comprising at least one similar region; and
a processing module, determining whether or not each temporal image having at least one similar object except the similar region, and integrating the similar object and the similar region to output an output image when the temporal images having the similar object.

8. The electronic apparatus of claim 7, wherein the processing module determines whether or not each temporal image having the similar object by variable block size motion compensation (VBSMC).

9. The electronic apparatus of claim 7, wherein when the processing module determines that the temporal images do not have the similar object, then the processing module determines whether or not each temporal image has at least one different object, and when the each temporal image has the different objects, the processing module integrating the different objects and the similar region to output the output image.
